(19) United States
(12) Patent Application Publication
(10) Pub. No.: US 2024/0186761 A1
(43) Pub. Date: Jun. 6, 2024

(54) RAMAN LASER ENGINE

(71) Applicant: Qioptiq Photonics GmbH & Co. KG, Goettingen (DE)

(72) Inventors: Frank Mueller, Muenchen (DE); Matthias Hans Lothar Anders, Dachau (DE); Bert Pilles, Goettingen (DE); Werner Harald Gabler, Muenchen (DE)

(73) Assignee: Qioptiq Photonics GmbH & Co. KG, Goettingen (DE)

(21) Appl. No.: 18/543,829

(22) Filed: Dec. 18, 2023

Related U.S. Application Data
(63) Continuation of application No. PCT/US2021/040322, filed on Jul. 2, 2021.

(51) Int. Cl. H01S 3/102; G02F 1/35; G02F 1/37; G02F 1/39; H01S 3/08; H01S 3/08036; H01S 3/081; H01S 3/083; H01S 3/0941; H01S 3/108; H01S 3/109; H01S 3/30

(52) U.S. Cl. CPC H01S 3/1026; G02F 1/3534; G02F 1/37; G02F 1/39; H01S 3/08036; H01S 3/0809; H01S 3/0815; H01S 3/09415; H01S 3/1083; H01S 3/109; H01S 3/30; H01S 3/083

(57) ABSTRACT

An illumination device for generating multiple wavelength, narrow linewidth, single longitudinal and single transversal mode emission, includes a laser-medium inside a laser-resonator configured to receive a pump beam from a single pump diode and produce a laser wave. Laser-resonator ingress and egress mirrors are configured to resonate the laser wave. An an OPO-resonator and OPO crystal are configured to receive the laser wave and produce short and long OPO waves. An OPO-resonator ingress mirror is configured to resonate the short OPO wave with the laser-resonator egress mirror. A nonlinear output crystal is configured to receive the short OPO wave and produce at least one output wave, wherein the the laser-resonator egress mirror is configured to emit at least two of the leaking out laser wave and the output waves.

### FIELD OF THE INVENTION

The present invention relates to a light source for Raman spectroscopy, and more particularly, is related to a light source consisting of a diode-pumped solid state laser and at least two different non-linear optical processes.

### BACKGROUND OF THE INVENTION

Raman spectroscopy is a common contact-free method for analyzing molecules via their interaction with light. Raman spectroscopy can be applied to any state of matter, preferably using laser light sources with narrow linewidth of 10 MHz or less. Common light wavelengths used for Raman spectroscopy are wavelengths around 532 nm, 633 nm, 785 nm and 1064 nm due to the common availability of these wavelengths, among others. Typical laser-technologies utilized for Raman spectroscopy include diode-pumped solid state lasers (DPSSL) with and without second-harmonic-generation (SHG), stabilized laser diodes, or HeNe-lasers. In Raman spectroscopy, shorter wavelengths (e.g., in the green 510-540 nm or blue 450-490 nm) provide higher excitation efficiencies, but shorter wavelengths often suffer from strong interference by fluorescence effects, especially for organic samples. Use of longer wavelengths (e.g., in red 610-695 nm or near-infrared 710-1210) may result in problematic heating of the sample. Practically, the best choice of wavelength depends upon the kind of sample being analyzed. In some scenarios where different kinds of samples are to be analyzed, compromise solutions include using 785 nm sources, or using a much more expensive laser-engine, for example, formed by a set of discrete lasers providing several wavelengths, as shown by FIG. 1. A light source 100 includes four discrete lasers 111-114, used individually or in combination to produce an output beam 130. For example, a 1064 nm DPSS-Laser 111 may produce a first beam directed to the output beam 130 by a first mirror 121. A 785 nm Diode-Laser 112 may produce a second beam combined with the first beam and directed to the output beam 130 by a second mirror/combiner 122. A 633 nm HeNe-Laser 113 may produce a third beam combined with the first beam and the second beam directed to the output beam 130 by a third mirror/combiner 123. A 532 nm DPSS-Laser with SHG 113 may produce a fourth beam combined with the first beam and the second beam and the third beam directed to the output beam 130 by a fourth mirror/combiner 124. The combination of four discrete lasers in the light source 100 is typically a bulky and expensive light source. Therefore, there is a need in the industry to address one or more of the abovementioned shortcomings.

### SUMMARY OF THE INVENTION

Embodiments of the present invention provide a light engine for Raman spectroscopy. Briefly described, the present invention is directed to an illumination device and method for generating multiple wavelength, narrow linewidth, single longitudinal and single transversal mode emission, includes a laser medium inside a laser-resonator configured to receive a pump beam from a single pump diode and produce a laser wave. Laser-resonator ingress and egress mirrors are configured to resonate the laser wave. An OPO-resonator and OPO crystal are configured to receive the laser wave and produce short and long OPO waves. An OPO-resonator ingress mirror is configured to resonate the short OPO wave with the laser-resonator egress mirror. A nonlinear output crystal is configured to receive the short OPO wave and produce at least one output wave, wherein the the laser-resonator egress mirror is configured to emit at least two of the leaking out laser wave and the output wave(s).

Other systems, methods and features of the present invention will be or become apparent to one having ordinary skill in the art upon examining the following drawings and detailed description. It is intended that all such additional systems, methods, and features be included in this description, be within the scope of the present invention and protected by the accompanying claims.

### BRIEF DESCRIPTION OF THE DRAWINGS

The accompanying drawings are included to provide a further understanding of the invention, and are incorporated in and constitute a part of this specification. The components in the drawings are not necessarily to scale, emphasis instead being placed upon clearly illustrating the principles of the present invention. The drawings illustrate embodiments of the invention and, together with the description, serve to explain the principles of the invention. In the drawings:

FIG. 1 is a general schematic drawing of a prior art Raman spectroscopy light source having four discrete typical Raman lasers.

FIG. 2A is a schematic drawing of an exemplary first embodiment of a light source.

FIG. 2B reproduces the laser-resonator portion of FIG. 2A, omitting the optical parametric oscillator (OPO) portion for clarity.

FIG. 3A is a schematic diagram relating two configurations of a second exemplary embodiment of a light source.

FIG. 3B is a detail of the third crystal of FIG. 3A with three crystal regions oriented in serial fashion to provide simultaneous SHG and SFG processes.

FIG. 3C is a detail of the third crystal of FIG. 3A with three crystal regions oriented in parallel fashion to provide one of the SHG and SFG at a time according to a translation of the third crystal.

FIG. 4A is a schematic diagram of a third exemplary embodiment of a light source.

FIG. 4B is a detail of the third crystal of FIG. 4A with exemplary plurality 3× of crystal regions oriented in x-parallel 3-series fashion.

FIG. 4C is a detail of the third crystal of FIG. 4A with a plurality of crystal regions oriented in parallel fashion to provide one of the SHG and SFG at a time according to a translation of the third crystal.

FIG. 4D is a detail of the OPO crystal 412 of FIG. 4A with a plurality x of OPO crystal regions oriented in parallel fashion to select different oscillation wavelengths of the OPO according to a translation of the OPO crystal 412.

FIG. 5A is a schematic diagram showing a first exemplary resonator configuration that may be adapted according to FIGS. 2A, 3A, and 4A.

FIG. 5B is a schematic diagram showing an exemplary common linear laser and OPO-resonator light source 5 that may be adapted according to FIGS. 2A, 3A, and 4A.

FIG. 5C is a schematic diagram showing an exemplary common laser- and OPO-ring-resonator light source that may be adapted according to FIGS. 2A, 3A, and 4A.

FIG. 6 is a flowchart of an exemplary embodiment of a method 600 for generating multiple wavelength, narrow linewidth, single longitudinal and single transversal mode emission, in a lighting device.

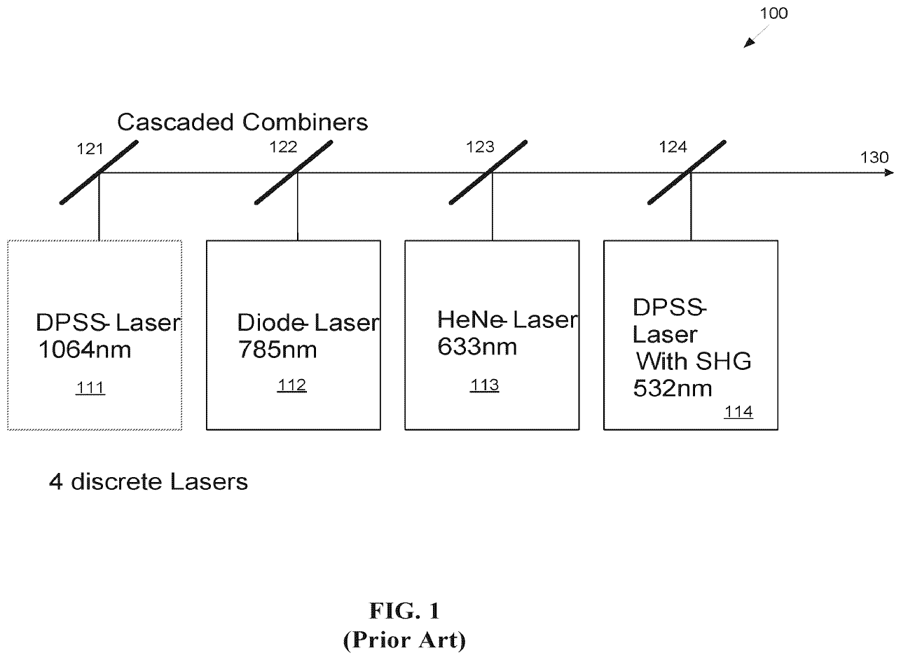

### DETAILED DESCRIPTION

The following definitions are useful for interpreting terms applied to features of the embodiments disclosed herein, and are meant only to define elements within the disclosure.

As used within this disclosure, a “diode-pumped solid state laser (DPSSL)” refers to a common Raman laser source. DPSSL consist of a broadband pump diode that pumps a laser-medium inside an optical resonator. Common pump-diodes used emit, for example, at 808 nm. Popular laser media for generating 1064 nm include, for example Nd: YAG, Nd:YVO4 or Nd: YLF. To ensure narrow linewidth single-longitudinal mode operation without mode-hops a wavelength selective element, for example a filter, grating, Brewster plate, or etalon, may be used. For further wavelength conversion, for example second-harmonic-generation (SHG) from 1064 nm to 532 nm, a nonlinear crystal may be used. Common non-linear optical (NLO) crystal materials may include, for example LiTaO3, LiNbO3 or KTP.

As used within this disclosure, an “optical parametric oscillator (OPO)” refers to a light source emitting radiation with properties comparable to that of a laser. OPOs are nonlinear devices that split short wavelength pump photons into two longer wavelength photons, namely signal and idler photons. The wavelengths of the signal and idler photons are not independent from each other, but may be tuned in wavelength. An OPO efficiently converts an input laser wave (the “OPO pump”) with frequency @p into two output waves of lower frequency (ωₛ, ωᵢ) via second-order nonlinear optical interaction. The sum of the frequencies of the output waves is equal to the input wave frequency: ωₛ+ωᵢ=ωₚ. For historic reasons, the output wave with the higher frequency ωₛ is called the signal (herein “short OPO wave”), and the output wave with the lower frequency ωᵢ is called the idler (herein “long OPO wave”). OPOs need an optical resonator, but in contrast to lasers, OPOs are based on direct frequency conversion in a nonlinear crystal rather than from stimulated emission. OPOs exhibit a power threshold for an input light source (pump), below which there is negligible output power in the signal and idler bands.

Examples of an OPO include an optical resonator (cavity) and a nonlinear optical crystal. The optical cavity is an arrangement of mirrors that forms a resonator for light waves. Light confined in the optical cavity is reflected multiple times resulting in multiple passes (a multi-pass) through the nonlinear crystal. The optical cavity serves to resonate at least one of the signal and idler waves. A wavelength selective element may be used to suppress unwanted mode-hops in the optical cavity. In the nonlinear optical crystal, the pump, signal, and idler beams overlap. Common crystal materials may include, for example LiNbO3, LiTaO3 or KTP.

The wavelength selection and wavelength tuning for SHG, SFG or OPO can be accomplished by the change of phase matching condition of the nonlinear crystals. Fine-tuning is usually done by changing the crystal temperature. A common means for coarse selection is the change of crystal angle. Quasi-phase matching can be done for ferro-electric crystals by periodically poling with different poling periods, allowing for manufacturing of crystals having locally different poling periods.

For an OPO-process the crystal is disposed inside a resonating cavity, while for SHG, SFG and DFG the crystal may optionally be disposed within a resonating cavity according to the needs of an application, for example if an enhancement of the power-level of a beam is desired. SHG is a specific type of SFG where two photons of equal wavelength interact.

As used within this disclosure, “regions” of a crystal refer to portions of a crystal that have different optical properties. For example, a crystal may be a composite of a plurality of discrete crystal regions, or in case of periodically poled crystals, a plurality of different poling periods on a single crystal or a plurality of crystals with perhaps one or more crystals having a plurality of poling periods. Regions of a crystal may be arranged in serial and/or parallel with a path of a transverse beam.

In general, “continuous wave” or “CW” refers to a laser that produces a continuous output beam, sometimes referred to as “free-running,” as opposed to a q-switched, gain-switched or mode locked laser, which has a pulsed output beam. A CW laser is distinguished from a pulsed laser. The embodiments described herein may be implemented with either a CW laser (preferred) or a pulsed laser device.

As used within this disclosure, “narrow linewidth” is determined relative to the context of the beam being discussed. For the OPO pump, narrow linewidth generally refers to a linewidth of less than 10 GHz. With regard to the resonated wave, “narrow linewidth” may be on the order of less than GHz range, or even MHz. Radiation that does not meet these requirements of a “narrow linewidth” is referred to herein as “broadband.”

As used within this disclosure, “beam quality” generally refers a quantitative measure of the quality of a laser beam and according to ISO standard 11146. M² is a dimensionless beam propagation parameter used to quantify this.

As used within this disclosure, “quasi-incoherent” means a transversally multi-mode light source with an M² value much larger than unity. For example, an M² squared value of three may be considered as quasi-incoherent, but a preferred quasi-incoherent source would have a M² value of eight or larger. Such a light source may also be referred to as having an M² value much larger than unity.

As used within this disclosure, “substantially” means very nearly, or to within manufacturing tolerances acceptable to a person having ordinary skill in the art. For example, substantially single transversal mode light refers to light produced by an OPO as would close to single transversal mode light as may be expected to be produced by an OPO.

As used within this disclosure, “substantially single transversal mode light” means a light source having a dominant contribution of a single transversal mode, preferably TEM00, for example with M² less than three. Other types of substantially single transversal mode light may be used, for example, TEM01.

As used within this disclosure, “mirror” refers to an optical element having at least one reflective surface. The reflective surface may reflect light received from one direction, but transmit light received from other directions. The reflective surface may reflect some wavelengths and transmit other wavelengths (dichroic reflector). Further the reflective surface may partially transmit and partially reflect some wavelengths. The reflective/transmissive properties may be due to the material of the mirror itself and/or coatings on one or more surfaces.

Reference will now be made in detail to embodiments of the present invention, examples of which are illustrated in the accompanying drawings. Wherever possible, the same reference numbers are used in the drawings and the description to refer to the same or like parts.

Exemplary embodiments of methods and devices under the present invention are directed to a compact Raman light source providing multi-wavelength single transversal and single longitudinal mode output in the visible to near-infrared region with narrow linewidth. Under the embodiments a light source which combines multiple technologies into a common cavity design, including a diode-pumped solid-state laser, intra-cavity second-harmonic-generation (SHG), intra-cavity sum-frequency-generation (SFG) and optical-parametric-oscillation (OPO). In general, the embodiments produce multiple Raman wavelengths based on the initial energy provided by a single pump-diode and being based on DPSSL plus nonlinear wavelength conversion. The embodiments produce a narrow linewidth, single-transversal, and single-longitudinal mode output. At least one emitted beam has a wavelength being between the wavelength of the DPSS laser-beam and its second harmonic, where it is understood a laser engine emits at least two different wavelengths.

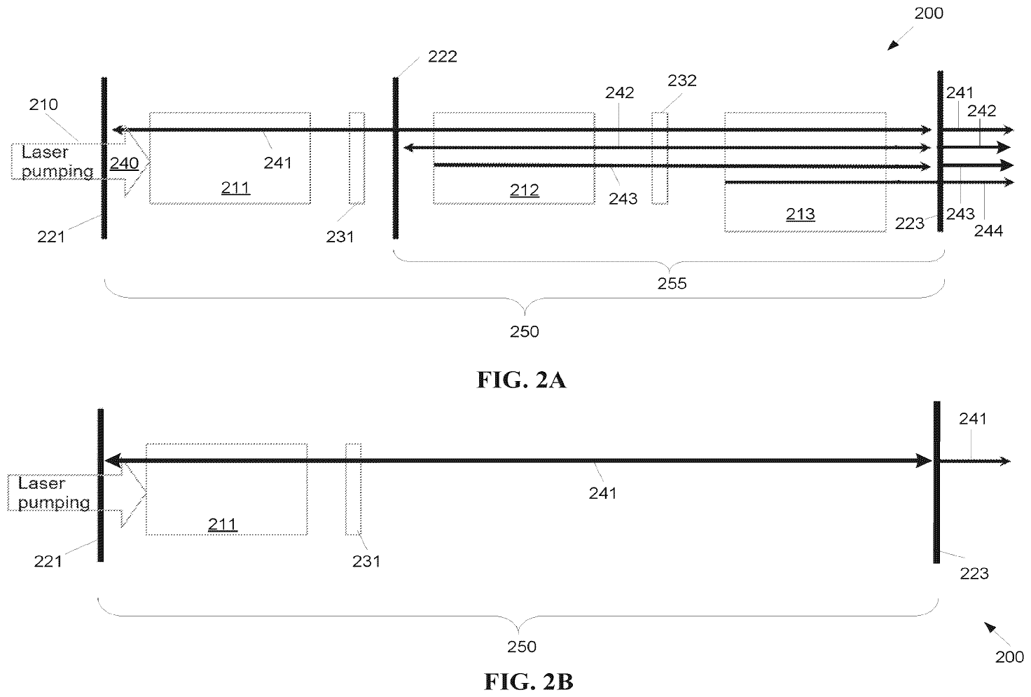

FIGS. 2A and 2B illustrate an exemplary first embodiment of light source 200. Here a laser-resonator 250 is formed by a first mirror 221 (“laser resonator ingress mirror”) and a third mirror 223 (“laser resonator egress mirror”), whereas an OPO-resonator 255 is formed by a second mirror 222 (“OPO-resonator ingress mirror”) and the laser-resonator egress mirror 223. FIG. 2B shows the diode pumped solid state laser (DPSSL): A pump diode 210, for example emitting radiation 249 broadly at 808 nm is directed through the laser-resonator ingress mirror 221 into a laser medium 211 inside a laser-resonator cavity 250 bounded by the laser-resonator ingress mirror 221 and the laser-resonator egress mirror 223. For example, Nd: YAG or ND:YVO4 are the most common laser media for generating wavelengths around 1064 nm.

FIG. 2A adds an OPO-resonator 255 to the laser-resonator 250 shown in FIG. 2B. A nonlinear crystal 212 configured for OPO-processes (“OPO crystal”) is disposed inside the laser-resonator 250 and the OPO-resonator 255 bounded by the OPO-resonator ingress mirror 222 and the laser-resonator egress mirror 223.

The laser medium 211 receives light (“pump beam” 240) from the pump diode 210 and generates a laser wave 241, for example at 1064 nm. The resonant laser wave 241 serves as pump beam for the OPO crystal 212. Both the laser-resonator ingress mirror 221 and the laser-resonator egress mirror 223 are highly reflective for the laser wave 241, although the laser-resonator egress mirror 223 may transmit (“leak”) a portion of the laser wave 241 through the laser-resonator egress mirror 223. Optionally, a first wavelength selective element 231, for example, an etalon or a grating, might be disposed inside the laser-resonator 250 to ensure single-longitudinal mode operation. The first wavelength selective element 231 may be tuned to select the laser wave 241.

The OPO crystal 212 receives the laser wave 241 and produces a resonant OPO wave (“short OPO wave”, signal wave) 242 and a non-resonant OPO wave (“long OPO wave”, idler wave) 243, where both the short OPO wave 242 and the long OPO wave 243 have longer wavelengths than the laser wave 241. The OPO-resonator ingress mirror 222 and the laser-resonator egress mirror 223 are each resonant for at least the shorter of the wavelengths (“short OPO wave 242”) generated by the OPO-process, where the laser wave 241 serves as the OPO pump. A second wavelength selective element 232 may optionally be disposed inside the OPO-resonator 255 to ensure single-longitudinal mode operation of the resonant short OPO wave 242. Element 232 might additionally serve as wavelength selective element for wave 141. In that case element 231 might not be required. As shown by FIG. 2A, the laser medium 211 may not be located within the OPO-resonator 255, although the laser medium 211 may be located within the OPO-resonator 255 in alternative embodiments.

The OPO-resonator 255 contains at least one nonlinear crystal 213 configured to produce an output wave 244 using at least one of the two following processes:
a) SHG (4) of the short OPO wave 242, and/or
b) SFG (5) of the short OPO wave 242 and the laser wave 241.
   When configured as an SFG, the crystal 213 should be within the laser-resonator 250 and the OPO-resonator 255. A crystal configured for SHG of the short OPO wave should be placed inside the OPO-resonator 255. Optionally, a fourth crystal (not shown) configured for SHG (6) of the laser wave 241 may be placed inside the laser-resonator 250.

For example, the laser-resonator ingress mirror 221 may be configured (for example via a coating) to be highly reflective of the laser wave 241 (for example, 1064 nm) and anti-reflective of the DPSSL 210 (for example, 808 nm). The OPO-resonator ingress mirror 222 may be anti-reflective for the laser wave 241 and highly reflective for the short OPO wave 242 (for example, 1570 nm). The laser-resonator egress mirror 223 may be highly reflective of the short OPO wave 242 and the laser wave 241, and anti-reflective for the emitted wavelengths 244 produced by the crystal 213 (for example, 532 nm, 634 nm, and 785 nm), and partially transmissive for the laser wave 241.

The laser medium 211 might be for example Nd: YVO4 or Nd: YAG, the OPO crystal 212, and/or the output crystal 213 might be for example doped or undoped LiNbO3, LiTaO3 or KTP, among other possible materials.

The properties of the emitted waves 241-242 include single transversal mode (STM), single longitudinal mode (SLM), M2<1.3, and narrow-linewidth, for example 10 MHz or less.

Various cavity-designs may be employed, for example, linear, folded, and/or ring cavities.

In general, preferred emission wavelengths are 532 nm, 610-695 nm (tunable or fixed), 720-1000 nm (tunable or fixed), and 1064 nm. As another example, the pump beam may be 1122 nm (instead of 1064 nm), and the emitted beams may be 561 nm (instead of 532 nm), 654 nm (instead of 634 nm), and 785 nm. The output power level may be in the range of 1-100 mW depending upon the wavelength and laser-pumping-power of the DPSSL 210, and the laser-pumping-power may be greater than 1W, as low as 1W or less than 1W.

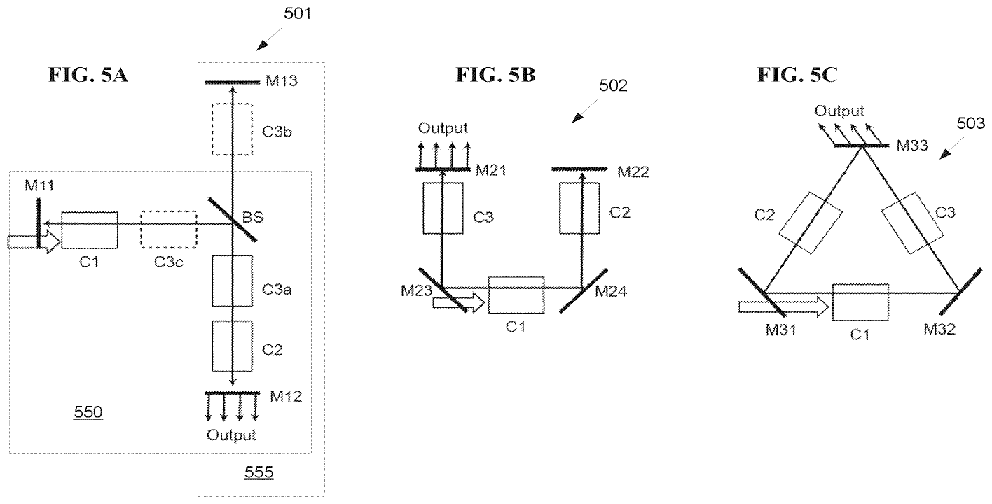

As described further below, for example regarding FIG. 5, there are alternative several cavity designs to the cavity arrangement of FIG. 2A.

In various configurations the embodiment the light source 200 may emit from two to four of the following wavelengths:
1) SHG (4) of the short OPO wave 242,
2) SFG (5) of the short OPO wave 242 and laser wave 241,
3) A fraction of the laser wave 241 leaking out of the laser-resonator, and
4) SHG (6) of the laser wave 241.

FIG. 2A depicts the processes of 1), 2) and 4) as utilizing a single output crystal 213, where the output crystal 213 may be configured to facilitate all three processes, for example using periodically poled crystals having several different poling periods. In other embodiments described further below the processes may utilize might a set of three different crystals.

While depictions of the embodiments show the mirrors as being discrete components, in alternative embodiments the reflective elements may be implemented, for example, as coatings on one or more of laser medium 211, the OPO crystal 212, and the output crystal 213. Similarly, instead of being implemented as discrete components, crystals and other optical components may be directly bonded to each other.

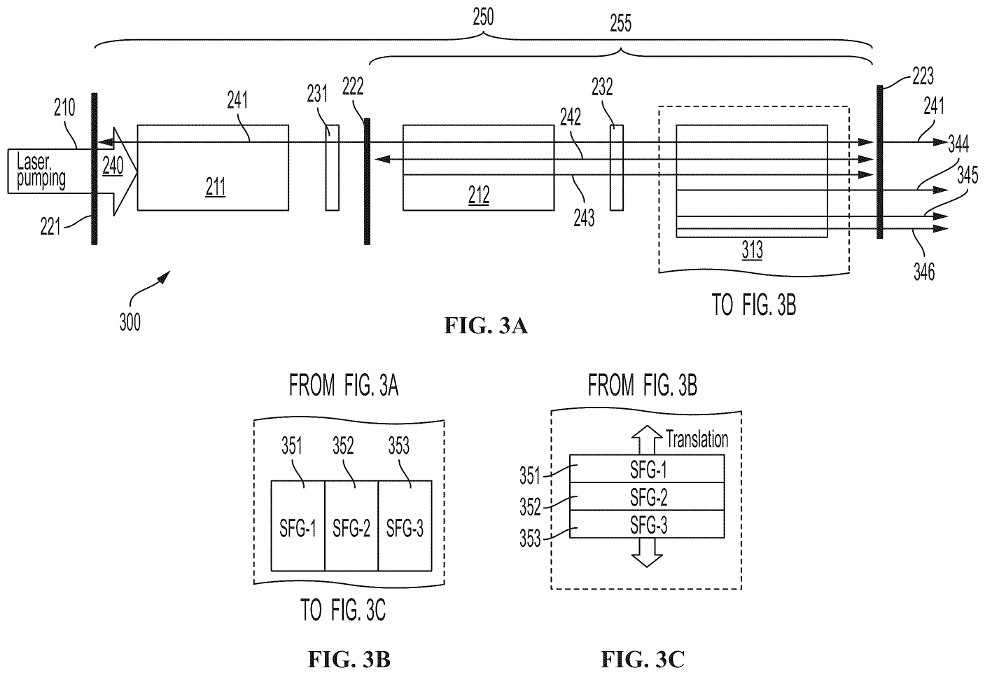

The wavelengths generated by the OPO are generally not relevant as output for Raman applications. As shown by FIG. 3A, a second exemplary embodiment of a light source 300 may be configured to output up to four wavelengths emitted at the same time or separately selectable. The second embodiment 300 may be viewed as an extension of the first embodiment 200 (FIG. 2A), with like element numbers refering to similar or identical elements. As shown by FIG. 3B, the output crystal 313 may have a first SFG region 351 configured to produce a first SFG wavelength 344, a second SFG region 352 configured to produce a second SFG wavelength 345, and a third SFG region 353 configured to produce the third SFG wavelength 346. For example, as shown in FIG. 3B, the three SFG regions 351-353 are arranged serially such that each of the beams 241, 242 passes through all three SFG regions 351-353 at the same time. It should be noted that while under the second exemplary embodiment the output crystal 313 is shown as a composite of three crystal regions, under alternative embodiments the output crystal 313 may be a composite of two, four, or more crystal regions. Alternatively, the output crystal 313 may be a single crystal with a plurality of poling periods, or a plurality of crystals where at least one crystal may also have a plurality of poling periods. It should also be noted that crystals labeled as SFG may be implemented as an SHG (which is a special case of SFG).

Alternatively, as shown in FIG. 3C, the three SFG regions 351-353 of the output crystal 313 are arranged in parallel such that each of the beams 241, 242 passes through the same one of the SFG regions 351-353 at the same time. For example, the output crystal 313 may be translated with respect to the OPO-resonator 255 in a direction normal to the beams 241, 242. The output crystal 313 may be manually and/or mechanically translated, for example, by mounting the output crystal 313 on a manually or motor controlled platform (not shown). One exemplary set of emission wavelengths 241, 344-346 be: 1) around 775 nm, 2) around 631 nm, 3) around 1064 nm and 4) around 532 nm, where “around” indicates+/−3 nm. Another exemplary set may be: 1) around 800 nm, 2) around 639 nm, 3) around 1122, 4) around 561 nm. It should be noted the crystal 313 does interact with the long OPO wave 243 (idler) for this embodiment. For example, the long OPO wave 243 may or not pass the crystal 313.

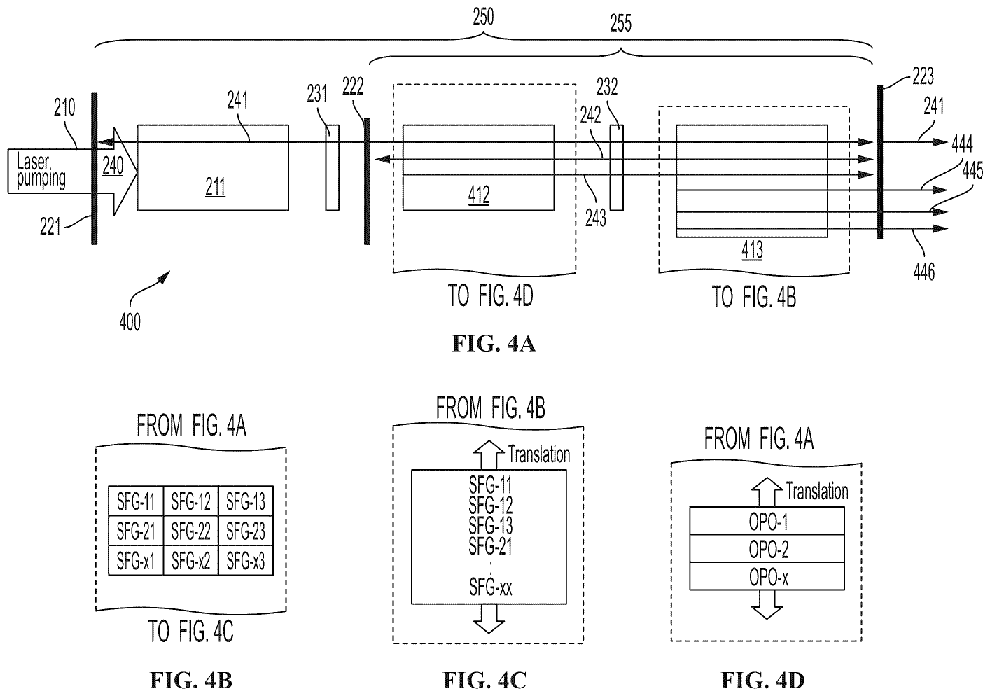

FIG. 4A is a schematic of an exemplary third embodiment of a light source. The third embodiment 400 may be viewed as an extension of the second embodiment 300 (FIG. 3A), with like element numbers referring to similar or identical elements. An OPO crystal 412 may be translated to select different wavelengths of the short OPO wave 242 and the long OPO wave 243. As consequence, an output crystal 413 becomes more complex than for the output crystal 313 (FIG. 3A) of the second embodiment 300 (FIG. 3). As shown by FIG. 4, under the third embodiment of a light source 400, the short OPO wave 242 produced by the OPO may be tuned in wavelength. This may either be achieved by temperature-tuning the OPO crystal 412 or physical translation of the OPO crystal 412, or both at once. For physical translation of the OPO crystal 412, the OPO crystal 412 may either incorporate different crystals with different phase-matching with putting one crystal after the other into the laser-beam, or by using a single periodically poled crystal having different poling lengths, for example multiple grating or fan-out grating, or a combination of both.

As a consequence of the complexity of the OPO crystal 412, likewise, the output crystal 413 becomes more complex. Under the third embodiment 400, the output crystal 413 may be implemented as having, for example, multi-poling periods, a collection of several crystals or include several crystals each having multi-poling periods. In alternative embodiments, the output crystal 413 may incorporate temperature change of for wavelength changes, for example, wavelength changes less than +/−10 nm. While the light source 400 of the third embodiment may appear schematically similar to the light source 300 of the first embodiment, however, under the third embodiment up to two of four emitted wavelengths 241, 444-446 may be tunable in wavelength, namely the SHG of the short OPO wave 242 and the SFG of the short OPO wave 242 and the laser wave 241. One exemplary set of emission wavelengths may be 1) selected from a range 730 to 950 nm, 2) selected from a range 615 to 682 nm, 3) around 1064 nm and 4) around 532 nm, where “around” indicates+/−3 nm.

FIGS. 5A-C show other exemplary resonator configurations that may be adapted according to the above described embodiment by a person skilled in the art. Some optics, such as optional wavelength selective elements, are omitted from the drawings for better visibility. FIG. 5A shows a folded linear cavity design light source 501 using a beam splitter (BS). The laser-resonator 550 is formed by mirrors M11 and M12, and is shown inside the dashed line. The OPO-resonator 555 is formed by mirrors M12 and M13 and is shown inside the dash-dot line. While the drawing depicts M12 as the egress mirror, in alternative embodiments M13 may be the egrees mirror, or both M12 and M13 may be egress mirrors. The laser crystal C1 is within in the laser-resonator 550 but not within the OPO-resonator 555. The OPO crystal C2 is within the laser-resonator 550 and the OPO-resonator 555.

Depending upon the desired functionality, one or more output crystals C3a, C3b, C3c may be distributed differently throughout the light source 501. For example, for SFG of the signal and laser waves, an output crystal C3a may be located within both resonators 550, 555.

For SHG of the signal wave, an output crystal C3b may be located within the OPO-resonator 555 and need not be within the laser-resonator 550. For SHG of the laser wave, an output crystal C3c may be located within the laser-resonator 550 and need not be within the OPO-resonator 555. As shown by these three examples, for a specific configuration an output crystal C3 may involve just one output crystal or up to three output crystals.

FIG. 5B shows an exemplary common linear laser and OPO-resonator light source 502 formed by M²¹ and M²². M²³ and M²⁴ serve as optional steering mirrors.

FIG. 5C shows an exemplary common laser- and OPO-ring-resonator light source 503. While FIG. 5C depicts the ring being formed by three mirrors M31, M32 and M33, for practical purposes a ring cavity is typically formed using more than three mirrors. Other examples of ring configurations include a single round ring mirror and a whispering gallery mode resonator, among others. While FIG. 5C depicts M33 the as egress mirror, in alternative embodiments, any one of or combination of mirrors M31, M32 and M33 may serve as an egress mirror for one or more of the emitted waves.

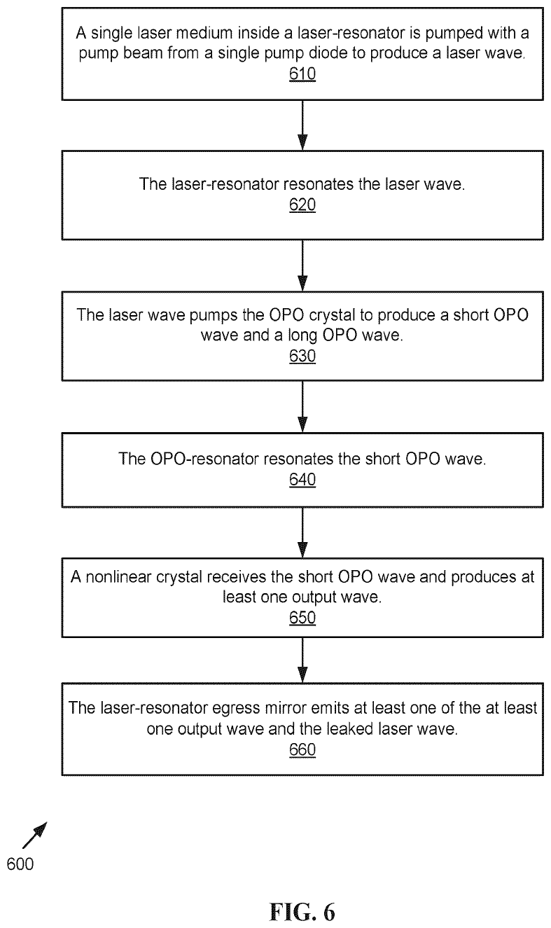

FIG. 6 is a flowchart of an exemplary embodiment of a method 600 for generating multiple wavelength, narrow linewidth, single longitudinal and single transversal mode emission, in a lighting device 200 having a nonlinear output crystal 213, an OPO-resonator 255 with an OPO-resonator ingress mirror 222 and a nonlinear OPO crystal 212, and a laser-resonator 250 including a laser-resonator ingress mirror 221, a laser-resonator egress mirror 223, a single laser medium 211 and the OPO-resonator 255. It should be noted that any process descriptions or blocks in flowcharts should be understood as representing modules, segments, portions of code, or steps that include one or more instructions for implementing specific logical functions in the process, and alternative implementations are included within the scope of the present invention in which functions may be executed out of order from that shown or discussed, including substantially concurrently or in reverse order, depending on the functionality involved, as would be understood by those reasonably skilled in the art of the present invention.

The method is described with reference to elements of FIG. 2A. A single laser medium 211 inside a laser-resonator 250 is pumped with a pump beam 240 from a single pump diode 210 to produce a laser wave 241, as shown by block 610. The laser-resonator 250 resonates the laser wave, as shown by block 620. The laser wave 241 pumps the OPO crystal 212 to produce a short OPO wave 242 and a long OPO wave 243, as shown by block 630. The OPO-resonator resonates the short OPO wave 242, as shown by block 640.

As shown in block 650, the nonlinear crystal 213 receives the short OPO wave 242 and produces 1 to 3 output waves 244 (at least one of the first two):
1) SHG of OPO wave 242
2) SFG of OPO wave 242 and the laser wave 241
3) SHG of laser wave 241.

For (2) and (3), the crystal 213 must also receive the laser wave 241. The up to 3 waves of 244 might be produced simultaneously of one at a time.

The laser-resonator egress mirror 223 emits at least one of the output wave(s) 244 and the leaking out laser wave 241, as shown by block 660. The laser-resonator egress mirror 223 may also emit (leak out) the non-used short and long OPO waves 242 and 243.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A method for generating multiple wavelength, narrow linewidth, single longitudinal and single transversal mode emission, in a lighting device comprising a nonlinear output crystal, an optical parametric oscillator (OPO) resonator comprising an OPO-resonator ingress mirror and a nonlinear OPO crystal, and a laser-resonator comprising a laser-resonator ingress mirror, a laser-resonator egress mirror, a single laser medium and the OPO-resonator, comprising the steps of:
receiving a pump beam from a single pump diode;
pumping the single laser medium inside the laser-resonator with the pump beam to produce a laser wave;
resonating the laser wave by the laser-resonator;
pumping the nonlinear OPO crystal with the laser wave;
producing by the nonlinear OPO crystal a short OPO wave and a long OPO wave;
resonating the short OPO wave by the OPO-resonator;
receiving the short OPO wave by the nonlinear output crystal to produce at least one output wave; and
emitting by the laser-resonator egress mirror at least a leaked portion of the laser wave and the at least one output wave.

2. The method of claim 1, wherein the laser-resonator egress mirror is further configured as an OPO-resonator egress mirror.

3. The method of claim 1, wherein the nonlinear output crystal is disposed within the OPO-resonator and configured for second harmonic generation (SHG) of the short OPO wave.

4. The method of claim 1, wherein the nonlinear output crystal is disposed within the OPO-resonator and the laser-resonator, and the nonlinear output crystal is configured for sum-frequency generation (SFG) of the short OPO wave and the laser wave.

5. The method of claim 1, wherein the nonlinear output crystal comprises a sum-frequency generation (SFG) region and a second harmonic generation (SHG) region.

6. The method of claim 1, wherein the nonlinear output crystal comprises a region configured for second harmonic generation (SHG) of the laser wave.

7. The method of claim 5, further comprising the step of translating the nonlinear output crystal with respect to the laser wave and/or the short OPO wave.

8. The method of claim 1, wherein the nonlinear OPO crystal comprises a first OPO region and a second OPO region.

9. The method of claim 8, further comprising the step of translating the nonlinear output crystal with respect to the pump beam.

10. The method of claim 1, further comprising the step of tuning the nonlinear OPO crystal and/or the nonlinear output crystal.

11. The method of claim 10, wherein tuning the nonlinear OPO crystal and/or the nonlinear output crystal further comprises at least one of the group of:
changing a temperature of the respective crystal, changing an angle of incidence of the respective crystal, and translating the respective crystal according to two or more regions of the respective crystal,
wherein the two or more regions of the crystals correspond to the group of OPO regions, second harmonic generation (SHG) regions, sum-frequency generation (SFG) regions, and periodic poling regions.

12. The method of claim 1, further comprising a wavelength selective element disposed within the laser-resonator and/or the OPO-resonator.

13. An illumination device for generating multiple wavelength, narrow linewidth, single longitudinal and single transversal mode emission, comprising:
a laser-resonator further comprising:
a single laser medium configured to receive a pump beam from a single pump diode and produce a laser wave;
a laser-resonator ingress mirror and a laser-resonator egress mirror configured to resonate the laser wave; and
an OPO-resonator;
the OPO-resonator further comprising:
an OPO crystal configured to receive the laser wave and produce a short OPO wave and a long OPO wave; and
an OPO-resonator ingress mirror configured to resonate the short OPO wave with the laser-resonator egress mirror; and
a nonlinear output crystal configured to receive the short OPO wave and produce at least one output wave,
wherein the laser-resonator egress mirror is configured to emit at least a leaking out laser wave and the at least one output wave.

14. The illumination device of claim 13, wherein the laser-resonator egress mirror is further configured as an OPO-resonator egress mirror.

15. The illumination device of claim 13, wherein the nonlinear output crystal is disposed within the OPO-resonator and configured for second harmonic generation (SHG) of the short OPO wave.

16. The illumination device of claim 13, wherein the nonlinear output crystal is disposed within the OPO-resonator and the laser-resonator, and the nonlinear output crystal is configured for sum-frequency generation (SFG) of the short OPO wave and the laser wave.

17. The illumination device of claim 13, wherein the nonlinear output crystal comprises a first second harmonic generation (SHG) region and a second SHG region.

18. The illumination device of claim 13 the nonlinear output crystal comprises a region configured for second harmonic generation (SHG) of the laser wave.

19. The illumination device of claim 17, wherein the nonlinear output crystal is configured to be translated with respect to the laser wave and/or the short OPO wave.

20. The illumination device of claim 13, wherein the OPO crystal comprises a first OPO region and a second OPO region.

21. The illumination device of claim 20, further comprising means for translating the nonlinear output crystal with respect to the pump beam.

22. The illumination device of claim 13, further comprising means for tuning the OPO crystal and/or the nonlinear output crystal.

23. The illumination device of claim 22, wherein the means for tuning the OPO crystal and/or the nonlinear output crystal further comprises at least one of the group of:
changing a temperature of the respective crystal, changing an angle of incidence of the respective crystal, and translating the respective crystal according to two or more regions of the respective crystal,
wherein the two or more regions of the crystals correspond to the group of OPO regions, second harmonic generation (SHG) regions, sum-frequency generation (SFG) regions, and periodic poling regions.

24. The illumination device of claim 13, further comprising a wavelength selective element disposed within the laser-resonator and/or the OPO-resonator.
